(19) United States
(12) Patent Application Publication
(10) Pub. No.: US 2018/0011456 A1
(43) Pub. Date: Jan. 11, 2018

(54) METHOD AND APPARATUS FOR SMART HOME CONTROL BASED ON SMART WATCHES

(71) Applicant: HUIZHOU TCL MOBILE COMMUNICATION CO.,LTD, Huizhou City,Guangdong (CN)

(72) Inventor: Libin ZHOU, Huizhou (CN)

(73) Assignee: HUIZHOU TCL MOBILE COMMUNICATION CO.,LTD, Huizhou City,Guangdong (CN)

(21) Appl. No.: 15/541,702

(22) PCT Filed: Aug. 10, 2016
(86) PCT No.: PCT/CN2016/094452

§ 371 Date: Jul. 5, 2017

(30) Foreign Application Priority Data
Dec. 29, 2015 (CN) 201511029251.3

(51) Int. Cl. G05B 15/02; H04L 12/28; G04G 21/00; H04W 76/02; G04B 47/06

(52) U.S. Cl. CPC G05B 15/02; H04W 76/02; G04B 47/06; G04G 21/00; H04L 12/282

(57) ABSTRACT

A method for controlling a smart home using a smart watch is disclosed. The method includes: detecting whether the smart watch has entered a sensing range of the smart home; detecting, after the smart watch has entered the sensing range of the smart home, whether the smart watch has established a wireless connection with the smart home; turning on, after the smart watch has established the wireless connection with the smart home, a smart-home-control function of the smart watch; and while controlling the smart home using the smart-home-control function, recognizing hand gestures of the user using the smart watch and controlling the smart home through the wireless connection to switch current working state of the smart home based on the recognized hand gestures of the user.

### TECHNICAL FIELD

This disclosure generally relates to the field of intelligent wearable devices, and more particularly, to a method of controlling smart homes based on using smart watches and the smart watches thereof.

### BACKGROUND

With the continuous development of smart watch technology, the research and development of the smart watch functions is also constantly improving to meet the various needs of users. Meanwhile, smart homes have been increasingly integrated into the people's daily life. Consequently, there is a growing interest and need to use a person's smart watch to control that person's smart home.

### SUMMARY

A principal technical problem to be addressed by the disclosure is to provide a method of controlling smart home solutions based on smart watches and the associated smart watches, for example, using a smart watch to control smart homes through recognizing the user's hand gestures.

According to an aspect of the disclosure, a smart watch including functions for controlling a smart home is disclosed that includes: a processor; a memory coupled to the processor and configured to store program instructions, wherein the processor is configured to execute the program instructions to: detect whether the smart watch has entered a sensing range of the smart home; after the smart watch has entered the sensing range of the smart home, detect whether the smart watch has established a wireless connection with the smart home; after the smart watch has established the wireless connection with the smart home, turn on a smart-home-control function of the smart watch; and while controlling the smart home using the smart-home-control function, recognize hand gestures of the user and control the smart home through the wireless connection to switch current working state of the smart home based on the recognized hand gestures of the user.

In some embodiments, the processor recognizes the hand gestures of the user by: sampling an arm movement of the user to obtain a multitude of movement status information, wherein the multitude of movement status information includes an acceleration and an angular velocity of the arm movement; obtaining a plurality of sets of three-dimensional (3D) coordinates of the arm movement based on the multitude of movement status information; obtaining a current characteristic value of the arm movement based on the plurality of sets of 3D coordinates; and recognizing a hand gesture of the user associated with the arm movement based on the current characteristic value.

In some embodiments, the processor recognizes the hand gesture of the user based on the current characteristic value by: detecting whether the current characteristic value is greater than a first threshold value; if the current characteristic value is less than or equal to the first threshold value, further detecting whether the current characteristic value is greater than a second threshold value; if the current characteristic value is greater than the second threshold value, determining that the hand gesture is an upward waving motion; and if the current characteristic value is less than or equal to the second threshold value, determining that the hand gesture is a hand-flipping motion.

In some embodiments, recognizing the hand gesture of the user based on the current characteristic value further includes: when the current characteristic value is determined to be greater than the first threshold value, further detecting whether the maximum value among the sets of 3D coordinates is equal to a predetermined value; and if the maximum value is equal to the predetermined value, determining that the hand gesture is a shaking motion.

In some embodiments, the processor is further configured to turn off the smart-home-control function of the smart watch when the smart watch has exited the sensing range of the smart home.

According to another aspect of the disclosure, a method for smart home control based on a smart watch is provided. The method includes: detecting whether the smart watch has entered a sensing range of the smart home; detecting, after the smart watch has entered the sensing range of the smart home, whether the smart watch has established a wireless connection with the smart home; turning on, after the smart watch has established the wireless connection with the smart home, a smart-home-control function of the smart watch; and while controlling the smart home using the smart-home-control function, recognizing hand gestures of the user using the smart watch and controlling the smart home through the wireless connection to switch current working state of the smart home based on the recognized hand gestures of the user.

In some embodiments, recognizing the hand gestures of the user using the smart watch includes: sampling an arm movement of the user to obtain a multitude of movement status information, wherein the multitude of movement status information includes an acceleration and an angular velocity of the arm movement; obtaining a plurality of sets of 3D coordinates of the arm movement based on the multitude of movement status information; obtaining a current characteristic value of the arm movement based on the plurality of sets of 3D coordinates; and recognizing a hand gesture of the user associated with the arm movement based on the current characteristic value.

In some embodiments, recognizing the hand gesture of the user based on the current characteristic value includes: detecting whether the current characteristic value is greater than a first threshold value; if the current characteristic value is less than or equal to the first threshold value, further detecting whether the current characteristic value is greater than a second threshold value; if the current characteristic value is greater than the second threshold value, determining that the hand gesture is an upward waving motion; and if the current characteristic value is less than or equal to the second threshold value, determining that the hand gesture is a hand-flipping motion.

In some embodiments, the method further includes the blocks of: if the current characteristic value is greater than the first threshold value, further detecting whether the maximum value among the multiple sets of 3D coordinates is equal to a predetermined value; and if the maximum value is equal to the predetermined value, determining that the hand gesture is a shaking motion.

In some embodiments, the method further includes the block of turning off the smart-home-control function of the smart watch when the smart watch has exited the sensing range of the smart home.

According to yet another aspect of the disclosure, a smart watch for a smart home is disclosed that includes: a first detection module disposed within the smart watch and configured to detect whether the smart watch has entered a sensing range of the smart home; a wireless connection module disposed within the smart watch and configured to establish a wireless connection between the smart watch and the smart home after the first detection module detects that the smart watch has entered the sensing range of the smart home; a control module coupled to the wireless module; and a smart-home-control module coupled to the control module. The control module is configured to control the smart-home-control module to turn on a smart-home-control function after the wireless connection module has established the wireless connection between the smart watch and the smart home. The smart-home-control module further includes a hand gesture recognition unit and a switching unit, wherein the hand gesture recognition unit is configured to recognize hand gestures of the user, and wherein the switching unit is configured to control the smart home through the wireless connection to switch current working state of the smart home based on the recognized hand gestures of the user.

In some embodiments, the hand gesture recognition unit is configured to recognize the hand gestures of the user by: sampling an arm movement of the user to obtain a multitude of movement status information, wherein the multitude of movement status information includes an acceleration and an angular velocity of the arm movement; obtaining a plurality of sets of 3D coordinates of the arm movement based on the multitude of movement status information; obtaining a current characteristic value of the arm movement based on the plurality of sets of 3D coordinates; and recognizing a hand gesture of the user associated with the arm movement based on the current characteristic value.

In some embodiments, the hand gesture recognition unit is configured to recognize the hand gesture of the user based on the current characteristic value by: detecting whether the current characteristic value is greater than a first threshold value; if the current characteristic value is less than or equal to the first threshold value, further detecting whether the current characteristic value is greater than a second threshold value; if the current characteristic value is greater than the second threshold value, determining that the hand gesture is an upward waving motion; and if the current characteristic value is less than or equal to the second threshold value, determining that the hand gesture is a hand-flipping motion.

In some embodiments, the hand gesture recognition unit recognizing the hand gesture of the user based on the current characteristic value further includes: if the current characteristic value is greater than the first threshold value, further detecting whether the maximum value among the sets of 3D coordinates is equal to a predetermined value; and if the maximum value is equal to the predetermined value, determining that the hand gesture is a shaking motion.

In some embodiments, the control module is further configured to, after the first detection module detects that the smart watch has exited the sensing range of the smart home, control the smart-home-control module to turn off the smart-home-control function.

Advantages of the disclosed techniques and devices can include the following. The present disclosure provides techniques for controlling smart homes based on using smart watches. More specifically, after a smart watch worn by a user enters the sensing range of a smart home, the smart watch establishes a wireless connection with the smart home and turns on the smart-home-control function. Using the smart-home-control function, the smart watch is able to recognize various hand gestures of the user and control the smart home through the wireless connection to switch current working state of the smart home based on the recognized hand gestures of the user. The proposed techniques and devices can realize the control of smart home via recognizing hand gestures of users using smart watches worn by the users, thereby meeting the needs of the users.

### BRIEF DESCRIPTION OF THE DRAWINGS

FIG. 1 is a flow diagram illustrating a method of controlling smart homes based on using smart watches according to an embodiment of the disclosure.

FIG. 2 is a flow diagram illustrating a detailed embodiment for recognizing the user's hand gesture according to the embodiment as illustrated in FIG. 1.

FIG. 3 is a block diagram of the disclosed smart watch according to an embodiment of the disclosure.

FIG. 4 is a block diagram of the disclosed smart watch or an equivalent device according to another embodiment of the disclosure.

### DETAILED DESCRIPTION

Certain terms are used in the detailed description and claims to refer to specific components, and those skilled in the art will appreciate that different terms may be used by the manufacturer to refer to the same components. The present specification and claims do not use the difference in the terms given to the components as a means of distinguishing components, but rather the functional differences of the components as a basis to distinguish different components.

The subject technology will now be described in detail with reference to the accompanying drawings and exemplary embodiments.

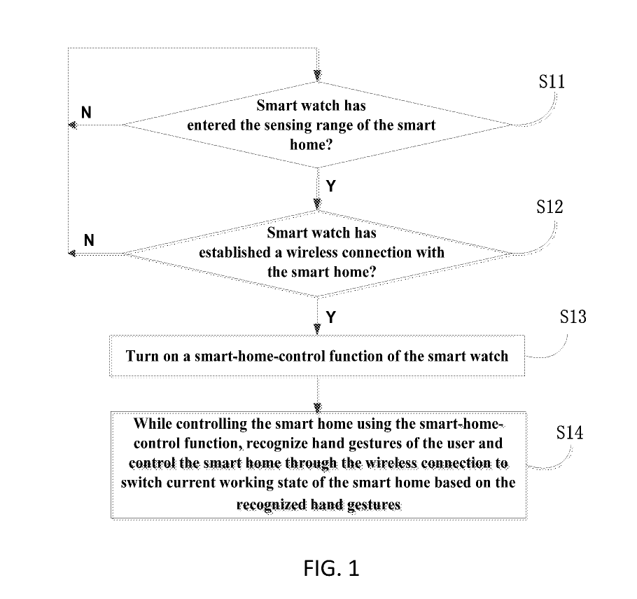

FIG. 1 is a flow diagram illustrating a method of controlling smart homes based on using smart watches according to an embodiment of the disclosure. Note that the blocks of the exemplary process shown in FIG. 1 may be performed in a different order than the order shown and/or one or more of the blocks of the exemplary process in FIG. 1 may be omitted in some embodiments. As shown in FIG. 1, the exemplary process can include the following blocks.

In block S11, whether a smart watch has entered the sensing range of a smart home is detected, and if so, block S12 may be executed. If not, block S11 may be repeated.

In some embodiments, detecting whether the smart watch has entered the sensing range of the smart home may further include the following blocks: acquiring the position of the smart home and marking the acquired position as the reference position; obtaining the position of the smart watch, for example, the position of the smart watch can be obtained via the GPS positioning module integrated with the smart watch; computing a distance between the position of the smart watch and the reference position and determining whether the distance is within the sensing range of the smart home.

In block S12, whether the smart watch has established a wireless connection with the smart home may be detected, and if so, block S13 may be executed. If not, block 11 may be executed.

In some embodiments of block S12, after the smart watch and smart home have established a wireless connection, the smart watch and the smart home can perform data communication. In some embodiments, the wireless connection can include, but are not limited to a Wi-Fi connection, a Bluetooth® connection, and an infrared connection.

In block S13, a smart-home-control function of the smart watch may be turned on. In some embodiments of block S13, after the smart watch and the smart home have established the wireless connection, the smart watch automatically turns on the smart-home-control function. In other embodiments, after the smart watch and the smart home have established the wireless connection, the smart home sends a request to turn on the smart-home-control function through the wireless connection. Next, after the smart watch has acknowledged the request of the smart home, the smart-home-control function is then turned on.

In block S14, while controlling the smart home using the smart-home-control function, the smart watch may be configured to recognize a hand gesture of the user and control the smart home through the wireless connection to switch current working state of the smart home based on the recognized hand gesture of the user.

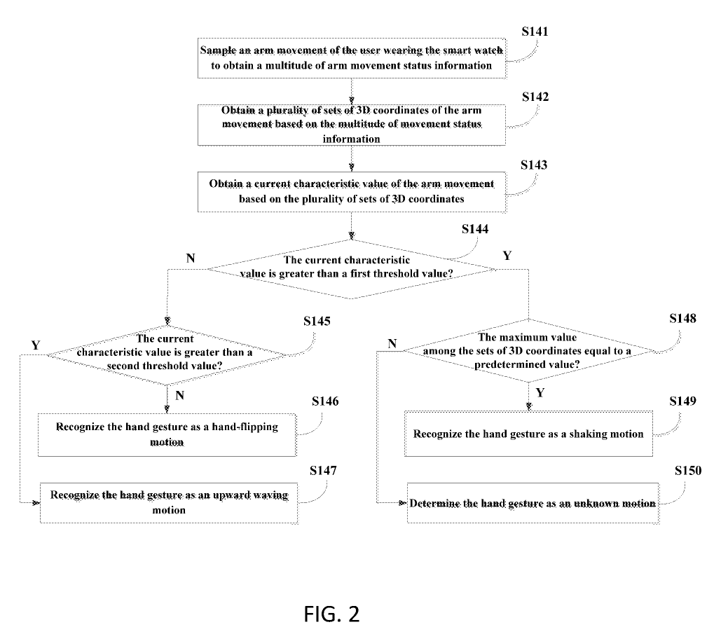

Now turning to FIG. 2, is a flow diagram illustrating a detailed embodiment for recognizing the user's hand gesture according to the embodiment as illustrated in FIG. 1. As shown in FIG. 2, the exemplary process can include the following blocks.

In block S141, an arm movement of the user wearing the smart watch may be sampled to obtain a multitude of arm movement status information. In some embodiments of block S141, because the smart watch may be generally worn on the user's arm, when the user's arm moves to make a different gesture, the arm movement status information of the user can be obtained by using an accelerometer and a gyroscope within the smart watch, wherein the arm movement status information may include an acceleration and an angular velocity of the arm movement. In other words, a plurality of sets of data can be measured within a predetermined time interval to obtain the arm movement status information corresponding to a plurality of points of time within the predetermined time interval.

In block S142, a plurality of sets of three-dimensional (3D) coordinates of the arm movement may be obtained based on the multitude of movement status information.

In one embodiment of block S142, a corresponding 3D coordinate of the arm may be obtained based on the arm movement status information corresponding to each point of time, thus a plurality of sets of 3D coordinates of the arm movement may be obtained.

In block S143, a current characteristic value of the arm movement may be obtained based on the plurality of sets of 3D coordinates. It can be appreciated that, because the characteristic information, i.e., the current characteristic value expressed in the arm movement status information obtained by the accelerometer and the gyroscope sampling may be different for different hand gestures, it is necessary to compute the current characteristic value of the arm movement based on the multiple sets of 3D coordinates and subsequently recognize the hand gesture of the user based on the obtained current characteristic value.

In block S144, whether the current characteristic value is greater than a first threshold value may be determined. If not, block S145 may be executed. Otherwise, block S148 may be executed.

In block S145, whether the current characteristic value is greater than a second threshold value may be determined. If not, block S146 may be executed. Otherwise, the block S147 may be executed.

In some embodiments, the second threshold value may be smaller than the first threshold value, and the values of the first threshold value and the second threshold value can be determined based on the actual situation. In one embodiment, when the second threshold value may be set to be close to the first threshold value, e.g., the first threshold value is set to 10 and the second threshold value is set to 8 an upward waving motion of the hand gesture can be more accurately recognized.

In block S146, the hand gesture may be recognized as a hand-flipping motion. More specifically in block S146, when the current characteristic value is less than or equal to the second threshold value, the hand gesture may be determined to be a hand-flipping motion.

In block S147, the hand gesture may be recognized as an upward waving motion. More specifically in block S147, when the current characteristic value is greater than the second threshold value but smaller than or equal to the first threshold value, the hand gesture may be determined to be an upward waving motion.

In block S148, whether the maximum value among the multiple sets of 3D coordinates is equal to a predetermined value may be determined. If so, block S149 may be executed. Otherwise, block S150 may be executed.

In some embodiments in block S148, when it is determined in block S144 that the current characteristic value is greater than the first threshold value, whether the maximum value among the multiple sets of 3D coordinates is equal to the predetermined value may be further determined. In some embodiments, the maximum value among the multiple sets of 3D coordinates can be the maximum value of the distances between the multiple sets of 3D coordinates and the origin of the coordinates.

In block S149, the hand gesture may be recognized as a shaking motion. More specifically, when the current characteristic value is greater than the first threshold value and the maximum value among the multiple sets of 3D coordinates is equal to the predetermined value, the hand gesture may be determined to be a shaking motion.

In block S150, the hand gesture is determined as an unknown motion. More specifically, when the current characteristic value is greater than the first threshold value and the maximum value among the multiple sets of 3D coordinates is not equal to the predetermined value, the hand gesture may be determined to be an unknown motion.

In some embodiments, when the smart watch recognizes the hand gesture of the user, the recognized hand gesture may be encoded into a command for switching the current working state of the smart home and transmits the command to the smart home via the wireless connection. After receiving the command, the smart home switches the current working state according to the command.

In some embodiments, because an upward waving motion of the hand gesture can be more accurately recognized than a hand-flipping motion or a shaking motion, it is preferable that after the smart watch recognizes an upward waving motion of the user's hand gesture, the smart watch may control the smart home to switch the current operating state based on the recognized upward waving motion.

In some embodiments, after the smart watch has left the sensing range of the smart home, the smart watch may disconnect the wireless connection from the smart home and turns off the smart-home-control function, thereby achieving power-saving of the smart watch.

The following is a specific example to illustrate the proposed smart home control technique. It is assumed that the user's living room is equipped with smart lights. When the user wearing a smart watch enters the living room and the sensing range of the smart lights, the smart watch may establish a wireless connection with the smart light and subsequently turns on the smart home control function. Next, when the smart watch recognizes an upward waving motion of the user's hand gesture, the smart watch may be configured to control the smart light to switch a current working state based on the recognized upward waving motion. More specifically, when the user waves the hand upward, the smart lights may be switched on; when the user waves again, the smart lights may be switched off. When the user leaves the living room and the sensing range of the smart lights, the smart watch may be configured to turn off the wireless connection with the smart lights, and switch off the smart-home-control function.

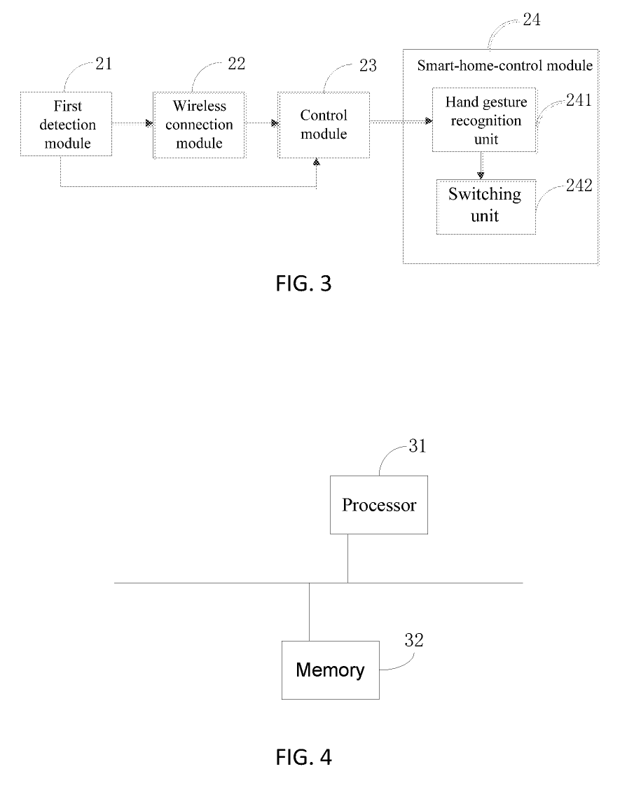

FIG. 3 is a functional block diagram of the disclosed smart watch according to an embodiment of the disclosure. As can be seen in FIG. 3, the smart watch may include a first detection module 21, a wireless connection module 22, a control module 23, and a smart-home-control module 24.

In some embodiments, the first detection module 21, which resides within the smart watch, may be configured to detect whether the smart watch has entered a sensing range of the smart home.

In some embodiments, the wireless connection module 22, which resides within the smart watch and is coupled to first detection module 21, may be configured to establish a wireless connection between the smart watch and the smart home after the first detection module 21 detects that the smart watch has entered the sensing range of the smart home. In some embodiments, the wireless connection module 22 may be further configured to disconnect the wireless connection between the smart watch and the smart home after the first detection module 21 detects that the smart watch has left the sensing range of the smart home. In some embodiments, the wireless connection can include, but are not limited to a Wi-Fi connection, a Bluetooth® connection, and an infrared connection.

In some embodiments, control module 23 may be coupled with the wireless connection module 22 and configured to control the smart-home-control module 24 to turn on the smart-home-control function after the wireless connection module 22 has established the wireless connection between the smart watch and the smart home. Furthermore, the control module 23 may be coupled to first detection module 21 and configured to control the smart-home-control module 24 to turn off the smart-home-control function after the first detection module 21 detects that the smart watch has left the sensing range the smart home.

In some embodiments, the smart-home-control module 24 may further include a hand gesture recognition unit 241 and a switching unit 242. The hand gesture recognition unit 241 may be coupled to control module 23 for recognizing hand gestures of the user. The switching unit 242 may be coupled to the hand gesture recognition unit 241 for controlling the smart home through the wireless connection to switch current working state of the smart home based on the recognized hand gestures of the user.

In some embodiments, the hand gesture recognition unit 241 may be configured to recognize the hand gestures of the user by: sampling an arm movement of the user to obtain a multitude of movement status information by using an accelerometer and a gyroscope within the smart watch, wherein the multitude of movement status information may include an acceleration and an angular velocity of the arm movement; obtaining a plurality of sets of 3D coordinates of the arm movement based on the multitude of movement status information; obtaining a current characteristic value of the arm movement based on the plurality of sets of 3D coordinates; and recognizing the hand gesture of the user based on the current characteristic value.

In some embodiments, the hand gesture recognition unit 241 may recognize the hand gesture of the user based on the current characteristic value by: detecting whether the current characteristic value is greater than a first threshold value; if the current characteristic value is less than or equal to the first threshold value, further detecting whether the current characteristic value is greater than a second threshold value; if the current characteristic value is greater than the second threshold value, determining that the hand gesture may be an upward waving motion; and if the current characteristic value is less than or equal to the second threshold value, determining that the hand gesture may be a hand-flipping motion.

In some embodiments, the hand gesture recognition unit 241 recognizing the hand gesture of the user based on the current characteristic value may further include: when the current characteristic value is detected to be greater than the first threshold value, further detecting whether the maximum value among the sets of 3D coordinates is equal to a predetermined value; if the maximum value is equal to the predetermined value, determining that the hand gesture may be a shaking motion; and if the maximum value is not equal to the predetermined value, determining that the hand gesture may be an unknown motion.

In some embodiments, the switching unit 242 controlling the smart home through the wireless connection to switch current working state of the smart home based on the recognized hand gestures of the user may include: when the hand gesture recognition unit 241 recognizes the hand gesture of the user, encoding the recognized hand gesture into a command for switching the current working state of the smart home and transmits the command to the smart home via the wireless connection, thereby causing the smart home to switch the current working state according to the received command.

Advantages of the disclosed techniques and devices can include the following. The present disclosure provides techniques for controlling smart homes based on using smart watches. More specifically, after a smart watch worn by a user enters the sensing range of a smart home, the smart watch establishes a wireless connection with the smart home and turns on the smart-home-control function. Using the smart-home-control function, the smart watch is able to recognize various hand gestures of the user and control the smart home through the wireless connection to switch current working state of the smart home based on the recognized hand gestures of the user. The proposed techniques and devices can realize the control of smart home via recognizing hand gestures of users using smart watches worn by the users, thereby meeting the needs of the users.

FIG. 4 is a block diagram of the disclosed smart watch or an equivalent device according to another embodiment of the disclosure. The smart watch or the equivalent device described in FIG. 4 can be used to perform the steps in the above-described processes, the details of which are described in the above-described processes in conjunction with FIGS. 1 and 2.

As can be seen in FIG. 4, the disclosed device may include a processor 31 and a memory 32 coupled to the processor 31. In some embodiments, the memory 32 may be used to store program instructions, the first threshold value, and the second threshold value.

In some embodiments, the processor 31 may be configured to execute the program instructions to achieve the following functions: detecting whether the smart watch has entered a sensing range of the smart home; after the smart watch has entered the sensing range of the smart home, detecting whether the smart watch has established a wireless connection with the smart home; after the smart watch has established the wireless connection with the smart home, turning on a smart-home-control function of the smart watch; and while controlling the smart home using the smart-home-control function, the processor 31 recognizing hand gestures of the user and controlling the smart home through the wireless connection to switch current working state of the smart home based on the recognized hand gestures of the user.

In some embodiments, the processor 31 may be further configured to: sample an arm movement of the user to obtain a multitude of movement status information, wherein the multitude of movement status information includes an acceleration and an angular velocity of the arm movement; obtain a plurality of sets of 3D coordinates of the arm movement based on the multitude of movement status information; obtain a current characteristic value of the arm movement based on the plurality of sets of 3D coordinates; and recognize a hand gesture of the user based on the current characteristic value.

In some embodiments, the processor 31 recognizing the hand gesture of the user based on the current characteristic value may include: detecting whether the current characteristic value is greater than a first threshold value; if the current characteristic value is less than or equal to the first threshold value, further detecting whether the current characteristic value is greater than a second threshold value; if the current characteristic value is greater than the second threshold value, determining that the hand gesture may be an upward waving motion; and if the current characteristic value is less than or equal to the second threshold value, determining that the hand gesture may be a hand-flipping motion.

In some embodiments, the processor 31 recognizing the hand gesture of the user based on the current characteristic value may further include: when the current characteristic value is determined to be greater than the first threshold value, further detecting whether the maximum value among the sets of 3D coordinates is equal to a predetermined value; and if the maximum value is equal to the predetermined value, determining that the hand gesture may be a shaking motion.

In some embodiments, the processor 31 may be further configured to turn off the smart-home-control function of the smart watch when the smart watch has exited the sensing range of the smart home.

In the embodiments of the present disclosure, it should be understood that the disclosed systems, devices, and techniques may be implemented in other ways. For example, the embodiments of the described systems and devices are merely for illustrative purposes. For example, the disclosed partitions of the disclosed modules and units merely include logical functional partitions, and the actual implementations can include other partition schemes. For example, multiple units or components may be integrated into another system, or some features may be omitted or may not be performed. In another embodiment, the illustrated or discussed mutual coupling, direct coupling or communication connection as described above may be an indirect coupling or a communication connection via one or more interfaces, devices, or units, and may be in an electrical form, a mechanical form, or other forms.

The units described as individual components may or may not be physically separated, and the components displayed as units may or may not be physical units; that is, the components displayed as units may be located in one place or may be distributed over a plurality of network units. Some or all of the units may be selected according to actual needs to achieve the purpose of the one or more embodiments of the present disclosure.

In addition, each functional unit in each embodiment of the present disclosure may be integrated in one processing unit, or each functional unit may exist as a discrete physical unit, or two or more units may be integrated into one unit. The above-mentioned integrated unit can be implemented in the form of hardware or in the form of a functional software unit.

The integrated unit as described above may be stored in a computer-readable storage medium if the integrated unit is implemented in the form of a functional software unit and sold or used as a standalone product. Based on this understanding, a technical solution disclosed in the present disclosure, a part of the technical solution which contributes to the state of the art, or the technical solution either in part or as a whole, can be embodied in the form of a software product that can be stored in a storage medium. The storage medium may include one or more instructions to enable a computing device (e.g., a personal computer, a server, or a network device) or a processor to perform all or parts of the processes as described in the one or more embodiments of the present disclosure. The storage medium as described above may include a USB flash drive, a removable hard disk, a ROM (Read-Only Memory), a random access memory (RAM), a magnetic disk, an optical disk, and other medium which can store program codes.

The above description merely depicts some exemplary embodiments of the present disclosure, but is intended to limit the scope of the present disclosure. It should be understood that any equivalent structural variations or equivalent process flow variations of the described embodiments and the accompanying drawings, or direct or indirect applications of the described embodiments and the accompanying drawings in other relevant technical fields, shall all be covered within the scope of protection of the present disclosure.

1. A smart watch, comprising:
a processor; and
a memory coupled to the processor and configured to store program instructions,
wherein the processor is configured to execute the program instructions to:
detect whether the smart watch has entered a sensing range of a smart home;
detect whether the smart watch has established a wireless connection with the smart home after the smart watch has entered the sensing range of the smart home;
turn on a smart-home-control function of the smart watch after the smart watch has established the wireless connection with the smart home; and
wherein the smart-home-control function comprises using the processor to:
recognize hand gestures of a user wearing the smart watch; and
control the smart home through the wireless connection to switch current working state of the smart home based on the recognized hand gestures of the user.

2. The smart watch according to claim 1, wherein the using the processor to recognize the hand gestures of the user comprises:
sampling an arm movement of the user to obtain a multitude of movement status information, wherein the multitude of movement status information comprises an acceleration and an angular velocity of the arm movement;
obtaining a plurality of sets of three-dimensional (3D) coordinates of the arm movement based on the multitude of movement status information;
obtaining a current characteristic value of the arm movement based on the plurality of sets of 3D coordinates; and
recognizing a hand gesture of the user associated with the arm movement based on the current characteristic value.

3. The smart watch according to claim 2, wherein the using the processor to recognize the hand gesture of the user based on the current characteristic value comprises:
detecting whether the current characteristic value is greater than a first threshold value;
when the current characteristic value is less than or equal to the first threshold value, further detecting whether the current characteristic value is greater than a second threshold value;
when the current characteristic value is greater than the second threshold value, determining that the hand gesture is an upward waving motion; and
when the current characteristic value is less than or equal to the second threshold value, determining that the hand gesture is a hand-flipping motion.

4. The smart watch according to claim 3, wherein the using the processor to recognize the hand gesture of the user based on the current characteristic value further comprises:
when the current characteristic value is determined to be greater than the first threshold value, further detecting whether the maximum value among the sets of 3D coordinates is equal to a predetermined value; and
when the maximum value is equal to the predetermined value, determining that the hand gesture is a shaking motion.

5. The smart watch according to claim 1, wherein the processor is further configured to turn off the smart-home-control function of the smart watch when the smart watch has exited the sensing range of the smart home.

6. A method for controlling a smart home based on a smart watch, the method comprising:
detecting whether the smart watch has entered a sensing range of the smart home; detecting, after the smart watch has entered the sensing range of the smart home,
whether the smart watch has established a wireless connection with the smart home;
turning on a smart-home-control function of the smart watch after the smart watch has established the wireless connection with the smart home; and
controlling the smart home using the smart-home-control function, which further comprises:
recognizing hand gestures of the user using the smart watch; and
controlling the smart home through the wireless connection to switch current working state of the smart home based on the recognized hand gestures of the user.

7. The method according to claim 6, wherein the recognizing the hand gestures of the user using the smart watch comprises:
sampling an arm movement of the user to obtain a multitude of movement status information, wherein the multitude of movement status information comprises an acceleration and an angular velocity of the arm movement;
obtaining a plurality of sets of 3D coordinates of the arm movement based on the multitude of movement status information;
obtaining a current characteristic value of the arm movement based on the plurality of sets of 3D coordinates; and
recognizing a hand gesture of the user associated with the arm movement based on the current characteristic value.

8. The method according to claim 7, wherein the recognizing the hand gesture of the user based on the current characteristic value comprises:
detecting whether the current characteristic value is greater than a first threshold value;
when the current characteristic value is less than or equal to the first threshold value, further detecting whether the current characteristic value is greater than a second threshold value;
when the current characteristic value is greater than the second threshold value, determining that the hand gesture is an upward waving motion; and
when the current characteristic value is less than or equal to the second threshold value, determining that the hand gesture is a hand-flipping motion.

9. The method according to claim 8, further comprising:
when the current characteristic value is greater than the first threshold value, detecting whether the maximum value among the multiple sets of 3D coordinates is equal to a predetermined value; and
when the maximum value is equal to the predetermined value, determining that the hand gesture is a shaking motion.

10. The method according to claim 6, further comprising turning off the smart-home-control function of the smart watch when the smart watch has exited the sensing range of the smart home.

11. A smart watch for controlling a smart home, comprising a processor and a non-transitory program storage medium containing a program product executable by the processor, the program product comprising:
a first detection module disposed within the smart watch and configured to detect whether the smart watch has entered a sensing range of the smart home;
a wireless connection module disposed within the smart watch and configured to establish a wireless connection between the smart watch and the smart home after the first detection module detects that the smart watch has entered the sensing range of the smart home;
a control module coupled to the wireless module; and
a smart-home-control module coupled to the control module,
wherein the control module is configured to control the smart-home-control module to turn on a smart-home-control function after the wireless connection module has established the wireless connection between the smart watch and the smart home;
wherein the smart-home-control module comprises:
a hand gesture recognition unit configured to recognize hand gestures of the user; and
a switching unit configured to control the smart home through the wireless connection to switch current working state of the smart home based on the recognized hand gestures of the user.

12. The smart watch according to claim 11, wherein the hand gesture recognition unit is configured to recognize the hand gestures of the user by:
sampling an arm movement of the user to obtain a multitude of movement status information, wherein the multitude of movement status information comprises an acceleration and an angular velocity of the arm movement;
obtaining a plurality of sets of 3D coordinates of the arm movement based on the multitude of movement status information;
obtaining a current characteristic value of the arm movement based on the plurality of sets of 3D coordinates; and
recognizing a hand gesture of the user associated with the arm movement based on the current characteristic value.

13. The smart watch according to claim 12, wherein the hand gesture recognition unit is configured to recognize the hand gesture of the user based on the current characteristic value by:
detecting whether the current characteristic value is greater than a first threshold value;
when the current characteristic value is less than or equal to the first threshold value, further detecting whether the current characteristic value is greater than a second threshold value;
when the current characteristic value is greater than the second threshold value, determining that the hand gesture is an upward waving motion; and
when the current characteristic value is less than or equal to the second threshold value, determining that the hand gesture is a hand-flipping motion.

14. The smart watch according to claim 13, wherein the hand gesture recognition unit recognizing the hand gesture of the user based on the current characteristic value further comprises:
when the current characteristic value is greater than the first threshold value, further detecting whether the maximum value among the sets of 3D coordinates is equal to a predetermined value; and
when the maximum value is equal to the predetermined value, determining that the hand gesture is a shaking motion.

15. The smart watch according to claim 11, wherein the control module is further configured to control the smart-home-control module to turn off the smart-home-control function after the first detection module detects that the smart watch has exited the sensing range of the smart home.

16. The method according to claim 6, wherein the detecting whether the smart watch has entered the sensing range of the smart home comprises:
acquiring a position of the smart home and marking the acquired position as a reference position; and
obtaining a position of the smart watch.

17. The method according to claim 16, wherein the position of the smart watch is obtained via a GPS positioning module integrated with the smart watch.

18. The method according to claim 17, further comprising computing a distance between the position of the smart watch and the reference position and determining whether the distance is within the sensing range of the smart home.
